(19) United States
(12) Patent Application Publication
(10) Pub. No.: US 2007/0146205 A1
(43) Pub. Date: Jun. 28, 2007

(54) Antenna array

(75) Inventor: Heiko Pelzer, Erkelenz (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,176

(22) PCT Filed: Feb. 22, 2005
(86) PCT No.: PCT/IB05/50633

§ 371 Date: Aug. 21, 2006

(30) Foreign Application Priority Data
Feb. 25, 2004 (EP) 04100734.5

(51) Int. Cl. H01Q 1/38

(52) U.S. Cl. 343/700 MS; 343/702

(57) ABSTRACT

The invention relates to a dielectric antenna comprising a substrate of a dielectric material and with a feed line on a front face of the substrate and a ground metalization on a rear face of the substrate, which ground metalization extends up to the front face of the substrate. These dielectric antennae can be designed for application in different frequency bands, for example GSM 900, GSM-PCS, GSM-PCS, UMTS, CDMA and Bluetooth.

The invention relates to a dielectric antenna comprising a substrate of a dielectric material. This substrate supports a feed line and a ground metalization.

Patch antennae for use in mobile telecommunication are known from U.S. Pat. No. 6,545,641 B2 or DE 100 49 843 A1. In principle, patch antennae have a very narrow bandwidth, if the height of the patch antennae is restricted. It is for this reason that patch antennae can be used only to a limited extent. Mobile telecommunication, however, needs considerable bandwidths to be able to make sending and receiving operations possible. Several substrates are arranged vertically one over the other for use in patch antennae in mobile telecommunication. This arrangement makes it possible to provide the bandwidth required in telecommunication. This stacking model correspondingly increases the size of the antenna. The dimensions of a GSM antenna of this design, which can be used for GSM 900 with the frequency range 880-960 MHz, are at least 19.4 mm×10.9 mm×4.0 mm. It is proposed to arrange this antenna with surface mounting as a surface mounted device on a board. The properties of the antenna depend on its position on the board, top or side position, so the antenna must be adapted to suit the assembly situation.

A dielectric block antenna that has a dielectric material substrate is known from US 20020067312 A1. This substrate supports a feed line and a ground metalization.

Electromagnetic waves in the microwave range are used in mobile telecommunication and wireless communication for transmitting information. Examples in the mobile phone range are GSM 900 in the frequency range from 880-960 MHz and GSM-DCS in Europe in the frequency range from 1710-1880 MHz.

The third generation of mobile telecommunication includes more bands in the UMTS range from 1880 MHz-2200 MHz and wideband CDMA from 1920 MHz-1980 MHz and 2110 MHz-2170 MHz. Bluetooth is used for communication between individual end devices in the frequency range from 2400 MHz-2483.5 MHz.

Mobile telephones equipped for use in different networks with corresponding antenna technology, which are called Tri-Band telephones, are already on the market today.

Efforts are directed towards offering ever smaller electronic devices. This makes it necessary also to provide increasingly smaller antennae and antenna systems to be able to equip these devices with antenna technology, which makes operation of these devices in several networks or further miniaturization possible.

Antennae cannot be just arranged next to each other, because with an arrangement close together the antennae can heavily affect each other, with the result that it is not possible to achieve the transmission and reception performance with adjacently arranged antennae that can be achieved when the antennae are used individually. This puts restrictions on the optimization of utilization of the given space.

It is an object of the invention to provide dielectric antennae, which have a compact structure, have excellent broadcasting properties and allow as flexible an application as possible.

The object of the invention is achieved by the antenna having features as claimed in claim 1.

The dielectric antenna as invented, also designated as dielectric block antenna, has a dielectric material substrate. This substrate supports a metalization on a front face, which metalization is connected, as a rule, to the 50 Ohm high-frequency feeder line of the application. This metalization is referred to as feedline below. The substrate bears another metalization on a back face, referred to as ground metalization below, which is linked to the ground metalization of an application and extends up to the front face of the substrate. This antenna as invented excels by its good reception and transmission characteristics and has a compact design.

In another version the ground metalization is configured with branches depending on the application, as a result of which branches (switches) the antenna has resonances in different frequency ranges. This makes it possible to use this antenna in several networks.

A particularly compactly structured antenna is described in claim 11, which antenna is suitable for use in mobile telecommunication and has a special arrangement of feed line and a main loop of a ground metalization.

Other advantageous measures are described in other dependent claims. These and other aspects of the invention are apparent from and will be elucidated, by way of non-limitative example, with reference to the embodiment(s) described hereinafter. In the drawings,

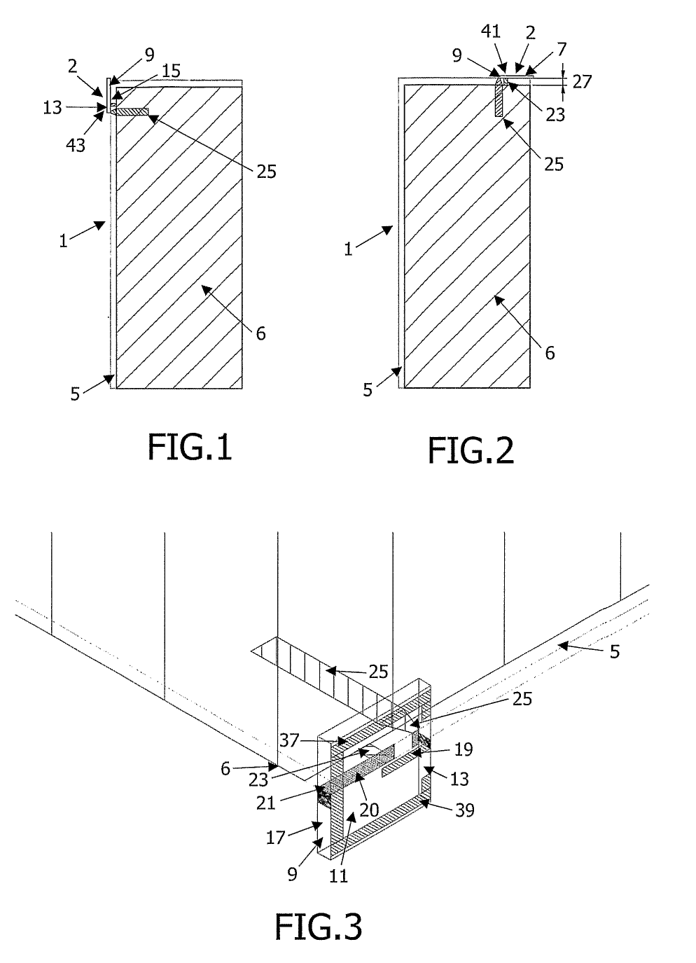

FIG. 1 shows a dielectric antenna in top position

FIG. 2 shows an antenna in side position

FIG. 3 shows an antenna for 2.4 GHz; 8 mm×8 mm×1 mm

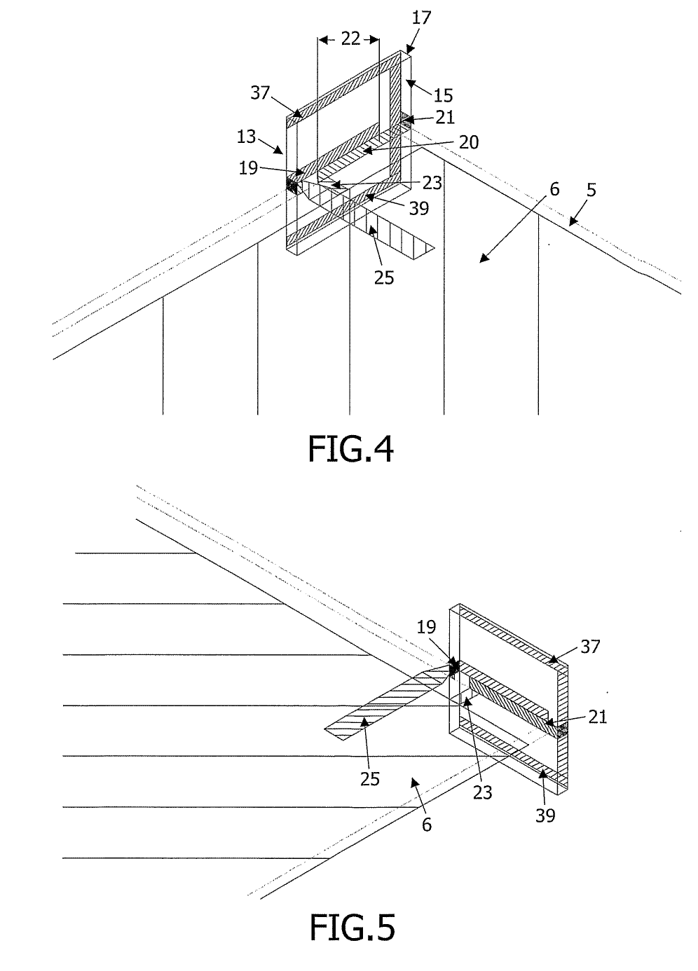

FIG. 4 shows a UMTS antenna with the dimensions 11 mm×11 mm×1 mm, 1880-2200 MHz

FIG. 5 shows a UMTS antenna from FIG. 4

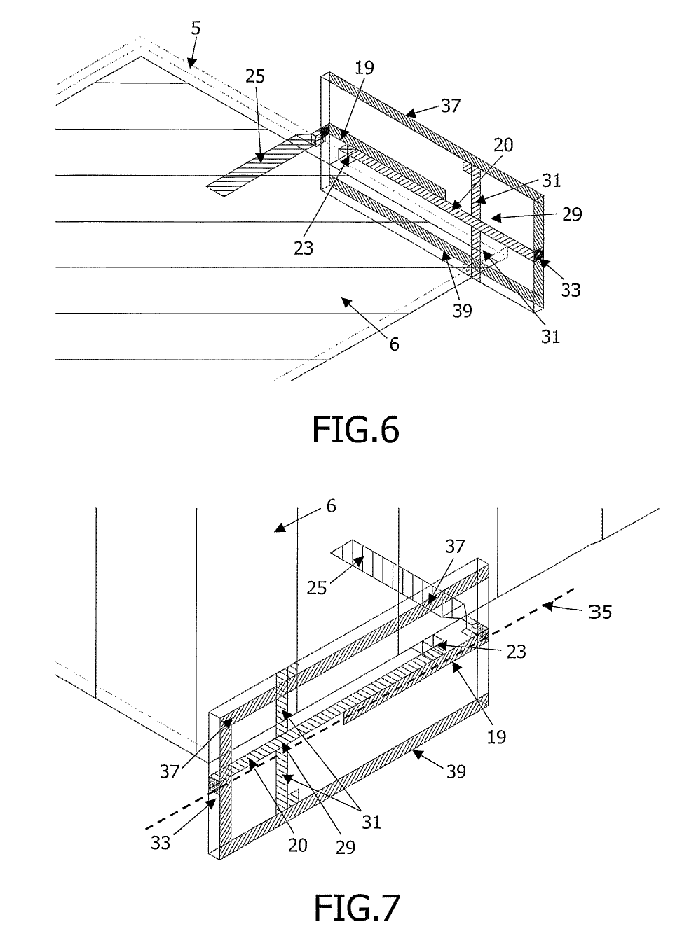

FIG. 6 and FIG. 7: show a dual band antenna for GSM 900 (880-960 MHz) and PCS (1859-1990 MHz)

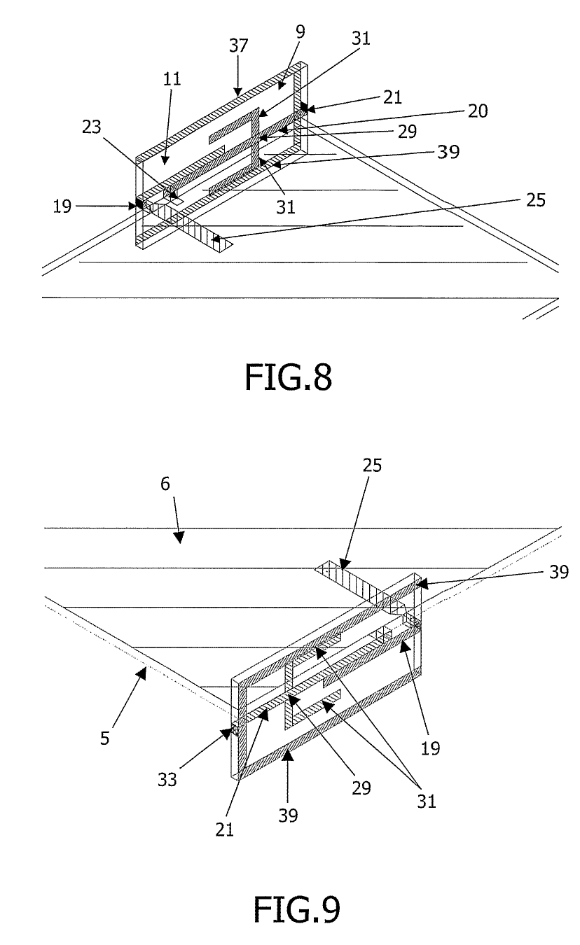

FIG. 8 and FIG. 9: show a dual band antenna for GSM 900 (880-960 MHz) and PCS (1710-1880 MHz)

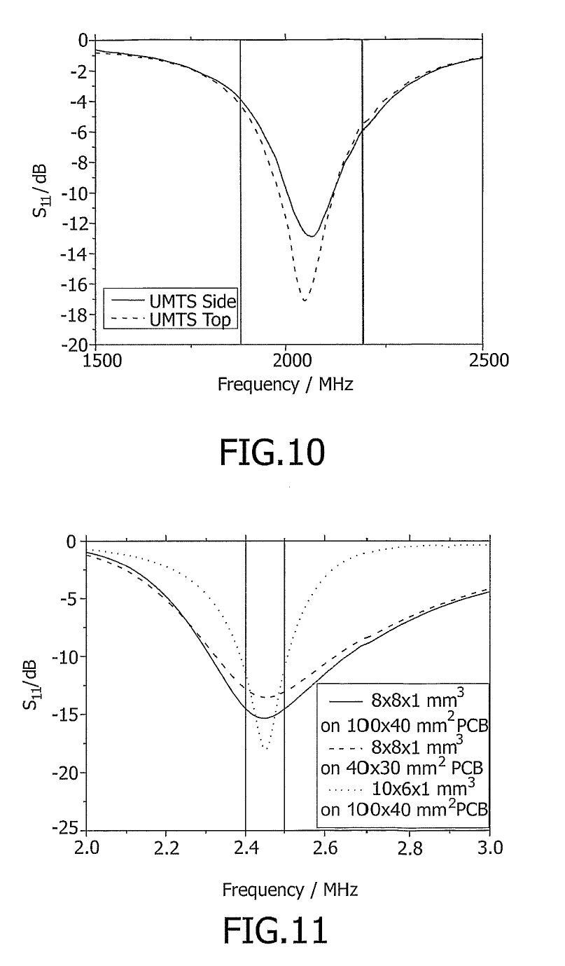

FIG. 10 gives a graphic representation of the measured S parameters of the antenna shown in FIGS. 4 and 5

FIG. 11 gives a graphic representation of the simulated S parameters of the antenna shown in FIG. 3 and an antenna with reduced component height with patch panels, Printed Circuit Boards (PCBs), of different sizes

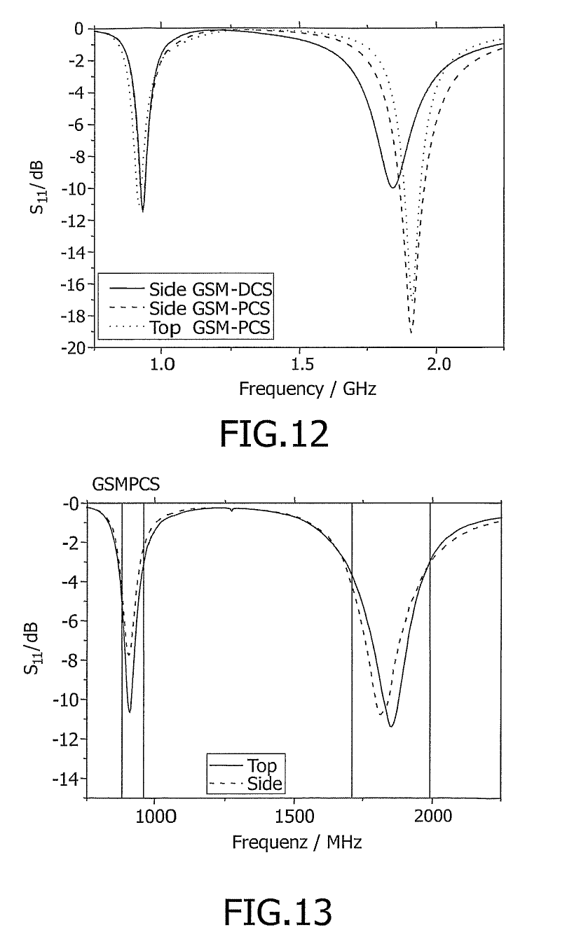

FIG. 12 gives a depiction of the simulated S parameters in dependence on the frequency of the antennae depicted in FIGS. 6 to 9

FIG. 13 gives a graphic representation of the measured S parameters of the antenna shown in FIGS. 8 and 9

FIGS. 1 and 2 each show a dielectric antenna 2 with a substrate 9 of a dielectric material 7, which is arranged perpendicular to a board 5, often also designated as patch panel. The patch panel is also designated as printed circuit board and abbreviated to PCB.

The vertical arrangement of the antennae 2 does not need any space on the PCB 5, which is advantageous. The antenna 2 can also be stored in a casing, not shown, of an electronic device such as a mobile telephone or a laptop, where only the electrical connection of the antenna 2 to the PCB 5 must be made available. This connection can be established by means of plug-in connectors. Such a flexible arrangement of the antenna 2 makes it possible to use existing spaces in an electronic device in an optimal manner. Thus, for example, the antenna 2 can be fastened in a housing by using a latched joint or adhered joint.

In the arrangements shown in FIGS. 1 and 2 the antenna 2 is fastened directly to the PCB 5 and perpendicular to it. It is then proposed that there is a minimum distance 27 between the antenna 2 and a metalization 6 of the PCB 5. This minimum distance 27 helps keep the effect on the antenna 2 by the PCB 5 low. The effect of the PCB 5 on the antenna will be explained later with the help of FIG. 11.

The performance parameters of antennae are affected not by the distance to a metalization 6 of a PCB 5, but by a multiplicity of parameters. Thus, for example, also the relative position of the antenna 2 to the PCB 5 affects the transmission and reception behavior of the antenna. This dependence will be observed in detail when the various examples of embodiments are described. FIGS. 1 and 2 show an antenna 2 in two different arrangement positions. Other positions are also possible for the arrangement of the antenna, especially an arrangement in the center of the casing.

FIG. 1 shows the dielectric antenna 2 arranged on a longer lateral edges of the PCB 5. The dielectric substrate 9 of the antenna 2 is arranged perpendicular to the plane of the PCB 5. This position is called side position 43.

FIG. 2 shows the dielectric antenna 2 arranged on the shorter lateral edge of the PCB 5. This arrangement is called top position 41.

The special design of the antenna makes it possible to adjust the antennae such that these antennae can be used for an arrangement in top position 41 as well as in side position 43 with almost the same performance, without having to make any adaptations in the design of the antenna 2. The arrangement of feed line 19 and ground metalization 21 on the substrate 9 is described with the design of the antenna 2.

The PCB 5 is needed to arrange, among other things, electronics required for operating the antenna (electronics not shown here). The antenna 2 together with the electronics mounted on PCB 5 form a transceiver unit 1.

The structure of an embodiment of a dielectric antenna 2 according to the invention will be described in detail with the help of FIG. 3. The antenna 2 shown in FIG. 3 is designed for the frequency range between 2.4 and 2.5 GHz. A dielectric material 11 is used as substrate material with a dielectric constant of ∈r=20.6. Typical materials are high-frequency compatible substrates with low loss and low temperature dependence on high-frequency characteristics. Such materials are known as NPO materials or what are called SL materials. The examples of embodiments shown have substrate 9 in block form with front face 13, rear face 15, short side faces 17 and long side faces 18.

The feed line 19 that starts from a short side face 17 extends on the front face 13 and is parallel to the edges of the long side faces 18. The feed line 19 is arranged centrally on the front face 13 and is half as long as the long side face 18. The feed line 19 is distinctly narrower than the length of the short side face 17. The ground metalization 21 of the antenna 2 has a main line 20, which is arranged on the rear face 15 of the substrate 9. This main line 20 is arranged centrally on the rear face 15 and parallel to the long bordering edges of the rear face 15. The main line 20 of the ground metalization 21 also extends only over a fraction of the length of the substrate 9 and continues on the short side face 17, which is located opposite the short side face 17, from which the feed line 19 starts and extends on the front face 13. The main line 20 of the ground metalization 21 extends completely over this side face 17 up to the front face 13. The main line 20 branches into the switch 33 in a first arm 37 and a second arm 39. These two arms 37, 39 are arranged mirror-symmetrically around an axis of symmetry 35, which runs parallel to the front face of the substrate and centrally to the border edges on the long side faces 18 of the front face 13. This axis of symmetry 35 is illustrated only in the example of embodiment shown in FIG. 7 for the sake of clarity.

When projecting the front face 13 and the rear face 15 in a plane parallel to these faces, the feed line 19 and the ground metalization 21 or part of the main line 20 cover each other over an area. This area is designated as overlap area 22 and is illustrated in FIG. 4.

The length of the overlap area 22 affects, on one hand, the position of the resonances and, on the other, the available bandwidth. This is achieved by varying the coupling point of the feed line 19 on the front face 13 of the substrate 9 in the resonant mass metallization 21 on the rear face 15 of the substrate with the frequency such that the effective length of the mass metallization 21 or the effective length of the main line 20 is dependent on frequency. The signal is thus launched in broadband. The launching can also be changed via the width of the ground line 21, which facilitates an adjustment of the antenna to the electrical environment in an application, which environment is affected for example by display, battery, loudspeaker and other conducting surfaces.

The symmetry and the parallelism of the switch 33 of the ground metalization 21 on the front face 13 of the substrate 9 in the first arm 37 and in the second arm 39 has a decisive effect, because minor deviations can cause a drastic reduction in the available bandwidth. The total length of the printed wiring of ground metalization 21 and feed line 19 and the dielectric constant of the substrate 9 predominantly determine the position of the resonance. Resonances can be moved exactly as required by changing these parameters.

The ground metalization 21 and the feed line 19, which are the metalization structures of the antenna 2, consist of an electrically highly conductive material such as silver, copper, aluminum or a superconductor.

Two electrical connections 23 and 25 are provided for connecting the feedline 19 and the ground metalization 21 to the PCB. The feed line 19 is contacted to a high-frequency feeder 25 through a contact placed on the short side face. The high-frequency feeder 25 generally has a resistance of 50 Ohms.

The design of the antenna 2 shown is distinguished by the fact that a coupling of the high-frequency signals is effected by a partly parallel conduit of the feed line 19 over the main line 20 of the ground metalization 21 as a resonance structure. This arrangement makes it possible to displace the entry point in dependence on the frequency. Together with the symmetrical structure of the ground metalization 21 as the resonance structure enables a better adjustment −14 dB in the frequency range between 2.4 and 2.5 GHz and a bandwidth of 390 MHz at −10 dB for an installation size of only 8×8×1 mm³. This compact antenna is designed for use in Bluetooth, WLAN and Home-RF arrangements.

The vertical arrangement of the substrate 9 in a mobile telephone is practicable, because the display is placed on one side of the PCB in a mobile telephone and on the other side of the PCB is always the battery. The vertical arrangement of the substrate 9 of the antenna 2 thus needs no enlargement in the component height for use in a mobile telephone and no space is needed on the PCB.

FIG. 11 shows the simulated S₁₁-parameter of the antenna shown in FIG. 3.

According to the simulated values of S11 parameter of the antenna shown in FIG. 11, the antenna 2 is adjusted through the frequency range of 2400-2500 MHz (Bluetooth, WLAN, Home RF) better than −14 dB while used with a PCB of 100 mm×40 mm. Thus, more than 95% of the energy can be brought into the antenna for the corresponding frequency, according to the simulation. A minimum distance of 27 of 2 mm from ground metalization 21 to metalization 6 of the PCB 5 is assumed here. The ground metalization 21 has an electrically conductive connection with the metalization 6 of the PCB 5 through the connection 23. For an adjustment of −10 dB the antenna has a bandwidth of 390 MHz.

FIG. 11 also shows the simulated S₁₁-parameter of the antenna 2 from FIG. 2 when used with a PCB of 40 mm×30 mm. On comparison, it becomes clear that the maximum of the resonance becomes wider and flatter on diminishing of the PCB. Furthermore, the simulated S₁₁ parameter of a modified antenna is shown in FIG. 11 for comparison, whose construction in principle remains the same as in FIG. 3, where the substrate dimensions have been modified. A PCB having the dimensions of 100 mm×40 mm was the basis for this simulation. It is also evident from the data of the S₁₁-parameters obtained from the simulation that the resonance or the maximum becomes narrower and taller with enlargement in the longitudinal extension of the substrate 9 and reduction in height of the substrate 9.

The example of embodiment shown in FIGS. 4 and 5 differs in its basic structure from the example of embodiment shown in FIG. 3 in that the arms 37 and 39 on the front face 13 have ends in the example of embodiment as shown in FIG. 3, which point to the feed line 19 arranged on the front face, as against which the arms of the antennae shown in FIGS. 4 and 5 end on the border edges of the short side faces 17 from which the feed line 19 starts. The remaining structure of the antenna as shown in FIGS. 4 and 5 is identical with the structure of the antenna described with the help of FIG. 3. For this reason, the remaining structure of the antenna shown in FIGS. 4 and 5 is not described in further detail.

This antenna is suitable for use in the frequency range of UMTS from 1880 MHz-2200 MHz and of CDMA from 1920 MHz-1980 MHz and 2110 MHz-2170 MHz. A substrate 9 having a dielectric constant 21 is selected. The substrate has the dimensions 11 mm×11 mm×1 mm. The minimum distance 27 of the ground metalization 21 of the antenna 2 to the metalization 6 of the PCB 5 should be 2 mm. This prevents the metalization of the PCB 5 from exerting a disproportionate influence on the antenna 2.

The measured S₁₁-parameters of this antenna are shown in FIG. 10. Furthermore, a maximum radiation efficiency i.e. component of the radiated energy absorbed by the antenna, of more than 90% has been measured in a reflection-free antenna chamber.

As can be seen from FIG. 10, the position of the resonant frequency of the antenna shown in FIGS. 4 and 5 is independent of the installation position. This alleviates the need for any special design for the different installation positions, thus reducing development costs and broadening the scope for application.

Two more embodiments of an antenna are shown in FIGS. 6 and 7 and FIGS. 8 and 9, which differ only a little from the examples of embodiment shown before. These antennae are multiband antennae for GSM 900 with GSM-DCS or GSM-PCS. A material with a dielectric constant of 21 is used as substrate 9 for both the embodiments. The dimensions of the two examples of embodiments are 24×11×1 mm³.

These examples of embodiment differ from the examples of embodiment described earlier in a switch of the ground metalization 21, designated as cross switch 29. This switch is arranged on the rear face 15 of the substrate 9. This cross switch 29 forms two arms 31, which run mirror symmetrically to the main line 20. The arms 31 each have a first section which runs perpendicularly to the main line 20. A second section of the arms connecting to the first section runs parallel to the main line 20, in which the ends of the second section are directed to the short side face 17, from which the feed line 19 starts. The two embodiments differ in the lengths of the first and second sections. It is possible to make a specific change in the position of the resonance of the antenna through the shape of the arms 31 and the position of the cross switch 29. More switches can be provided for realizing more resonances.

FIG. 12 shows the simulated S₁₁-parameters in top position and in side position of the antenna shown in FIGS. 6 and 7, as well as the simulated S₁₁-parameters in side position of the antenna shown in FIGS. 8 and 9.

The radiation efficiencies of this antenna have been measured in the measuring chamber. In the GSM 900 frequency band the maximum radiation efficiency is more than 90% and in the DCS frequency band it is more than 80%, if the antenna is placed in the side position. In general, the radiation is affected by the installation position to a limited extent.

FIG. 13 shows the measured S₁₁ parameters of the antennae shown in the FIGS. 8 and 9 for positioning in top position and side position in comparison with the simulated S₁₁ parameters shown already in FIG. 12. In comparison with the simulated data shown in FIG. 12, the adjustment in the frequency range from 1710-1990 MHz is even sufficient for a triple band application (DCS+PCS).

### LIST OF REFERENCE DRAWINGS

1 Transceiver unit
2 Antenna
3 Housing
5 PCB
6 Metalization of the PCB
7 Dielectric antenna
9 Substrate
11 Dielectric material
13 Front face
15 Rear face
17 Short side face
18 Long side face
19 Feed line
20 Main line
21 Ground metalization
22 Overlapping area
23 Ground terminal
25 High-frequency feeder/connection
27 Minimum distance
29 Cross switch
31 Arms
33 Switch
35 Axis of symmetry
37 First arm
39 Second arm
41 Top position
43 Side position

1. A dielectric antenna comprising a substrate (9) of a dielectric material (11) and comprising a feed line (19) on a front face (13) of the substrate (9) and a ground metalization (21) on a rear face (15) of the substrate (9), which ground metalization (21) extends up to the front face (13) of the substrate (9).

2. A dielectric antenna as claimed in claim 1, characterized in that the ground metalization (21) comprises a main line (20), which is arranged on the rear face and which is aligned parallel to the feed line (19) arranged on the front face (13).

3. A dielectric antenna as claimed in claim 2, characterized in that feed line (19) and ground metalization (21) have an overlapping area (22), in which feed line (19) and ground metalization (21) or main line (20), as the case may be, come to an overlap in the case of projection of front face (13) and rear face (15) of the substrate (9).

4. A dielectric antenna as claimed in claim 3, characterized in that the overlapping area (22) is smaller than 70%, preferably smaller than 50% of the length of the substrate (9) in the direction of extension of the feed line (19).

5. A dielectric antenna as claimed in claim 2, characterized in that a metalization (19, 21) is arranged on the front face (13) and on the rear face (15) of the substrate on the central axis of the substrate (9).

6. A dielectric antenna as claimed in claim 1, characterized in that the ground metalization (21) has two arms (37, 39) on the front face (13).

7. A dielectric antenna as claimed in claim 6, characterized in that the two arms (37, 39) are arranged parallel to the feed line (19).

8. A dielectric antenna as claimed in claim 6, characterized in that the two arms (37, 39) of the ground metalization (21) have identical lengths on the front face (13).

9. A dielectric antenna as claimed in claim 6, characterized in that the two arms (37.39) are arranged mirror symmetrically around an axis of symmetry (35).

10. A dielectric antenna as claimed in claim 1, characterized in that the ground metalization (21) has a cross switch (29) on the rear face (15).

11. A dielectric antenna for mobile telecommunication comprising a substrate made of a dielectric material and a feed line (19) on a front face of the substrate (9) and a main line (20) of a ground metalization (21), aligned parallel to the feed line on the rear face (15) of the substrate (9).

12. A circuit board with an antenna as claimed in claim 1.

13. A PCB (5) as claimed in claim 12, characterized in that the substrate (9) of the antenna (2) is arranged perpendicular to the PCB (5).

14. A PCB (5) as claimed in claim 13, characterized in that the substrate (9) is suitable for arrangement in top position (41) as well as in side position (43).

15. A transceiver unit comprising a housing (3) and a PCB (5) as claimed in claim 10, characterized in that the antenna (2) is connected firmly to the support with the housing (3) and is electrically connected to the PCB (5).

16. A method of manufacturing a transceiver unit with a housing (3) in which an antenna (2) comprising a substrate (9) is mounted and this antenna (2) is connected electrically to a PCB (5) through a high-frequency feeder (25) and a ground terminal (23).
